(19) United States
(12) Patent Application Publication
(10) Pub. No.: US 2025/0355614 A1
(43) Pub. Date: Nov. 20, 2025

(54) MICROPHONE DEVICES FOR LOCAL USERS PARTICIPATING IN MEETING IN WHICH REMOTE USER IS ALSO PARTICIPATING

(71) Applicant: Hewlett-Packard Development Company, L.P., Spring, TX (US)

(72) Inventors: Yelena Helen Balinsky, Bristol (GB); Rebecca Norlander, Vancouver, WA (US)

(21) Appl. No.: 18/664,049

(22) Filed: May 14, 2024

(51) Int. Cl. G06F 3/16; G10L 15/06; G10L 17/00; G10L 21/0208; H04N 7/15

(52) U.S. Cl. CPC G06F 3/165; G10L 15/06; G10L 17/00; G10L 21/0208; H04N 7/15

(57) ABSTRACT

From each of a number of microphone devices respectively worn by a number of local users participating in a meeting and physically present at a place of the meeting, a processor wirelessly receives speech uttered by a corresponding local user and detected by the microphone device, and metadata identifying the corresponding local user. The processor determines a group of the local users that a remote user participating in the meeting and not physically present at the place of the meeting is interested in hearing. The processor causes a computing device of the remote user to output just the speech uttered by each local user of the determined group of the local users that the remote user is interested in hearing, using the metadata identifying the corresponding local user of each microphone device.

### BACKGROUND

Meetings often required in-person participation, where people had to be physically present at the place of a meeting in order to participate in the meeting. With the advent of audioconferencing technology and more recently videoconferencing technology, virtual and hybrid meetings are now possible. In virtual meetings, there is no physical meeting place, and instead participants log into the meeting from their computers (either individually or in small groups). In hybrid meetings, there is an actual meeting place at which those who are referred to as local participants are physically present. Other participants, who are referred to as remote participants, can attend the meeting virtually, by logging in from their computers as in virtual meetings.

### BRIEF DESCRIPTION OF THE DRAWINGS

FIG. 1 is a diagram of an example hybrid meeting architecture in which local participants wear microphone devices.

FIGS. 2A and 2B are diagrams of example hybrid meeting architectures that are modifications of FIG. 1.

FIG. 3 is a diagram of an example in which a remote user participating in a hybrid meeting can explicitly select the group of local users he or she is interested in talking to, hearing, and otherwise engaging with or participating in a discussion with.

FIGS. 4A, 4B, and 4C are diagrams depicting an example in which a remote user participating in a hybrid meeting can more implicitly select the group of local users he or she is interested in talking to, hearing, and otherwise engaging with or participating in a discussion with.

FIGS. 5A and 5B are diagrams depicting another example in which a remote user participating in a hybrid meeting can more implicitly select the group of local users he or she is interested in hearing.

FIGS. 6A, 6B, 6C, and 6D are flowcharts of example methods that can be performed by a hub computing device or a server computing device for a hybrid meeting.

FIG. 7A is a block diagram of an example non-transitory computer-readable data storage medium storing program code that can be executed by a computing device of a remote user of a hybrid meeting. FIG. 7B is a diagram of additional processing that can be executed by the computing device of the remote user.

FIG. 8A is a block diagram of an example microphone device that can be worn by a local user of a hybrid meeting. FIGS. 8B and 8C are flowcharts of example processing that can be performed by the microphone device.

### DETAILED DESCRIPTION

As noted in the background, in hybrid meetings some participants are local and other participants are remote. The local participants are physically present at the place of the meeting, such as a conference or meeting room. The remote participants, by comparison, are not physically present at the meeting place, but instead participate virtually using their computing devices, such as desktop, laptop, or notebook computers, smartphones, tablet computing devices, and other types of computing devices.

Remote participants may have difficulty participating in impromptu breakout meetings of the local participants and side conversations of small groups of the local participants. For example, the meeting place may have a few microphones dispersed throughout the room. If a particular local participant is primarily responsible for presenting at the meeting, just the main microphone may be turned on, and the other microphones turned off.

Therefore, if other local participants have breakout meetings or side conversations, remote participants may not be able to hear them. Moreover, even if the other microphones remain on, the remote participants may not be able to identify who is speaking. If multiple side conversations or breakout meetings occur, the remote participants may not be able to discern which local participants are participating in which side conversations or breakout meetings.

As another example, the microphone or microphones at the meeting place may be primarily used by local participants who are presenters. Other local participants may be considered attendees of the meeting, in that they are not presenting at the meeting. When the attendees wish to ask questions, they may not be in close proximity to a microphone, and therefore other participants and the presenters may struggle to hear them. Therefore, the presenters have to repeat the questions, or the attendees have to wait to receive a microphone before asking their questions. Otherwise, the remote participants will not be able to hear the questions.

Techniques described herein ameliorate these shortcomings of hybrid meetings. In particular, each local participant wears his or her own microphone device. When the microphone device detects audio, it transmits the audio to a hybrid meeting hub device or cloud service, along with metadata identifying its wearer. The microphone device may be calibrated so that it just transmits audio that is speech uttered by its wearer, or audio other than the wearer's speech may be removed by the hub device or cloud service.

A remote participant can implicitly or explicitly select which local participants he or she is interested in hearing. Therefore, at the remote participant's computing device, just the speech uttered by these local participants is output. The remote participant is thus easily able to participate in breakout meetings and side conversations. Moreover, when a local participant speaks, the remote participant's computing device can highlight who is speaking so the remote participant can easily discern this information.

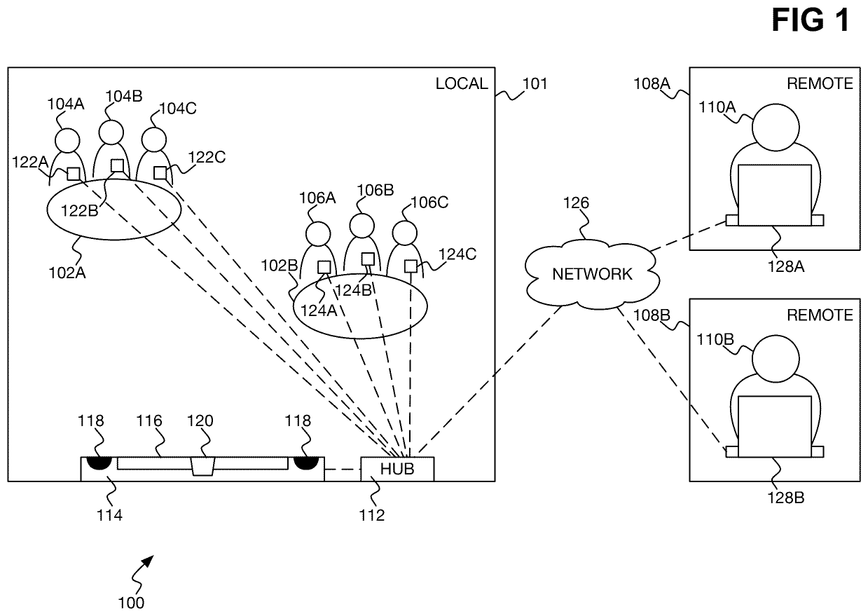

FIG. 1 shows an example architecture 100 for a hybrid meeting. The hybrid meeting includes local participants 104A, 104B, and 104C (collectively referred to as local participants 104) and local participants 106A, 106B, and 106C (collectively referred to as local participants 106), as well as remote participants 110A and 110B (collectively referred to as remote participants 110). The participants 104, 106, and 110 are users—i.e., individual people.

The local participants 104 and 106 are physically present at the place 101 of the meeting. By comparison, the remote participants 110 are not physically present at the meeting place 101. In the example, the local participants 104 are at one physical location 102A within the meeting place 101, and the local participants 104 are at another physical location 102B within the place 101, where the physical locations 102A and 102B are collectively referred to as the physical locations 102.

For instance, the meeting place 101 may be a room, and the physical locations 102 may each correspond to a different table within the room around which the local participants 104 or 106 or seated. In the example, there are six participants 104 and 106, but more generally there may be more or fewer participants 104 and 106. Similarly, in the example there are two physical locations 102 at each of which three participants 104 or 106 are located, but in general there may be more or fewer locations 102 and more or fewer participants 104 or 106 at each location.

There can be a computing device 114 or system of devices within the meeting room that includes a display 116, speakers 118, and/or a video camera 120 such as a webcam. The display 116 can display images of the remote participants 110 for viewing by the local participants 104 and 106 of the meeting. The speakers 118 can similarly output audio (i.e., uttered speech) of the remote participants 110 so that the local participants 104 and 106 can hear the remote participants 110. The video camera 120 may record video of the meeting place 101 so that the remote participants 110 can view the local participants 104 and 106. There may be multiple video cameras 120 as well, with corresponding video feeds, where each video camera 120 is focused on a different location 102 within the meeting place 101.

The remote participants 110A and 110B are respectively located at remote places 108A and 108B (collectively referred to as the remote places 108), which may be the homes of the participants 110, remote work sites, or other locations, such as coffee shops, hotel rooms, and so on. There may be more than one remote participant 110 at a given remote place 108. More generally, while in the example there are two remote places 108 that each include a single remote participant 110, there may be more or fewer remote places 108 that each include one or more remote participants 110.

The remote participants 110A and 110B respectively have their own computing devices 128A and 128B (collectively referred to as the remote computing devices 128). In the case in which there is more than one remote participant 110 at a given remote place 108, each participant 110 may have his or her own computing device 128, or multiple participants 110 may share the same computing device 128. The computing devices 128 may be desktop, laptop, or notebook computers, smartphones, tablet computing devices, or other types of computing devices.

The computing devices 128 record audio and/or video of their respective remote participants 110—and thus can include microphones and video cameras (such as webcams)—so that the local participants 104 and 106 can listen to and/or see the remote participants 110. The computing devices 128 further output the speech uttered by the local participants 104 and 106, via speakers. The computing devices 128 may also output the video of the local participants 104 and 106 as recorded by the video camera 120.

The local participants 104A, 104B, and 104C respectively wear their own individual microphone devices 122A, 122B, and 122C (collectively referred to as the microphone devices 122), and the local participants 106A, 106B, and 106C likewise respectively wear their own individual microphone devices 124A, 124B, and 124C (collectively referred to as the microphone devices 124). The microphone devices 122 and 124 may each be a purpose-built device that is used just for hybrid meetings, an example of which is described later in the detailed description, or may be a more general-purpose device, such as a smartphone including wired or wireless headphones or a wired or wireless headset. The microphone devices 122 and 124 may also be a basic device, including just an audio sensor (e.g., the microphone itself), and a wireless transmitter.

Each microphone device 122 and 124 detects audio in the proximity of the device 122 and 124, including at least speech uttered by its corresponding local participant 104 or 106 who is wearing the device 122 or 124 in question. Each microphone device 122 and 124 may transmit all the audio it detects, or just the audio that constitutes speech uttered by its wearer. In the latter case, for instance, a microphone device 122 or 124 may before transmission filter the detected audio to remove or reject audio other than speech uttered by its wearer.

Because each local participant 104 and 106 has his or her own microphone device 122 or 124, the hybrid meeting architecture 100 ensures that the remote participants 110 will be able to hear (as desired) the local participants 104 and 106 when the participants 104 and 106 speak. The microphone devices 122 and 124 thus record speech uttered by their respective participants 104 and 106 so that the remote participants 110 can hear them. Even if local participants 104 and 106 have side conversations or breakout meetings, the remote participants 110 will still be able to hear them, and the participants 104 and 106 can speak without first waiting for a microphone to be handed to them. Furthermore, multiple side conversations or breakout meetings among the local participants 104 and 106 can occur in parallel, such that the remote participants 110 can each choose which side conversation or breakout meeting they would like to participate in.

When transmitting at least the uttered speech of their respective local participants 104 and 106, the microphone devices 122 and 124 also transmit metadata identifying their respective local participants 104 and 106. The metadata permits the remote participants 110 to identify who is speaking, by virtue of their remote computing devices 128 receiving the metadata along with the uttered speech for playback. Furthermore, the metadata permits each remote participant 110 to listen to just local participants 104 and 106 who the participant 110 is particularly interested in hearing. The audio signals transmitted by the microphone devices 122 and 124 are handled separately, so that signals from individual microphone devices 122 and 124 can be switched off by a given remote participant 110 without impacting the other remote participants 110.

For a particular local participant 104 or 106, the metadata transmitted by a corresponding microphone device 122 or 124 may be an explicitly added identifier specific to that participant 104 or 106, or specific to that device 122 or 124. In the former case, a local participant 104 or 106 may when first wearing a microphone device 122 or 124 identify him or herself on the device 122 or 124 so that the device 122 or 124 transmits an identifier specific to the participant 104 or 106 when the device 122 or 124 transmits audio.

In the latter case, the microphone device 122 or 124 may have its own identifier that is unique as compared to the other microphone devices 122 and 124, and which is transmitted regardless of the specific local participant 104 or 106 wearing the device 122 or 124. Which local participant 104 or 106 is wearing which microphone device 122 or 124 may be stored in advance, such as when a local participant 104 or 106 first wears a given device 122 or 124.

In this case, then, when a microphone device 122 or 124 transmits audio, it transmits its own identifier (as opposed to an identifier specifically corresponding to the local participant 104 or 106 wearing the device 122 or 124). Which local participant 104 or 106 is wearing the microphone device 122 or 124 can then be looked up based on the identifier that the device 122 or 124 transmits. The metadata identifying the local participant 104 or 106 can thus be an identifier that particularly identifies the microphone device 122 or 124.

The metadata may in this case not be an explicitly added identifier corresponding to the microphone device 122 or 124 in question. Rather, the metadata may be part of data that is automatically wirelessly transmitted in a networking environment. For example, when the detected audio is transmitted within network packets, each packet may include the source (i.e., sender) by network address. Therefore, the metadata may be an implicitly included identifier for a given microphone device 122 or 124 (and thus for a given local participant 104 or 106) insofar as the detected audio is sent within network packets that identify the device 122 or 124 sending the packets.

In the example of FIG. 1, the microphone devices 122 and 124 wirelessly transmit at least the uttered speech of their respective local participants 104 and 106 to a hub computing device 112 that is physically located within the meeting place 101. The hub computing device 112 may be a standalone computer that is particularly programmed to perform its functionality. The hub computing device 112 is communicatively connected to a network 126, which may be or include the Internet, for instance.

The remote computing devices 128 of the remote participants 110 are similarly communicatively connected to the network 126. The hub computing device 112 transmits the uttered speech of the local participants 104 and 106, as detected by microphone devices 122 and 124 respectively worn by the participants 104 and 106, to the remote computing devices 128 via the network 126. The hub computing device 112 receives the audio and/or video of the remote participants 110 from their respective remote computing devices 128 via the network 126, for playback on the speakers 118 and/or display 116, respectively.

The hub computing device 112 also can transmit the video of the local participants 104 and 106 recorded by the video camera 120 to the remote computing devices 128 via the network 126. The hub computing device 112 in the example of FIG. 1 is separate from the computing device 114 including the display 116, speakers 118, and/or video camera 120. However, in another implementation, the hub computing device 112 and the computing device 114 may be integrated within the same device.

In the example of FIG. 1, there is one meeting place 101 in which multiple local participants 104 and 106 are present, and there are remote participants 110 in respective remote places 108. However, in another implementation, there can be multiple meeting places 101 that each include multiple local participants 104 and 106. In this case, the participants 104 and 106 in the various meeting places 101 and the participants in their respective remote places 108 can all participate in the same meeting. For instance, the different meeting places 101 may be meeting rooms located in different geographic areas.

The difference between a meeting place 101 and a remote place 108 in this case can be that a meeting place 101 has a richer videoconferencing technology setup, including a display 116, speakers 118, and/or a video camera 120, and/or a meeting place 101 may otherwise set up for having multiple local participants 104 and 106 present. By comparison, a remote place 108 may be an ad hoc location where one or more given remote participants 110 happen to currently be (e.g., a hotel room, a coffee shop, and so on), and/or that otherwise does not have as rich of a videoconferencing technology setup (e.g., in the case of a home office). Further, a meeting place 101 may be able to accommodate more local participants 104 and 106 than the number of remote participants 110 that a remote place 108 can accommodate.

In the example of FIG. 1, there are speakers 118 for the entire meeting place 101. However, in another implementation, there may additionally or instead be one or more speakers at each location 102 within the meeting place 101. In this case, the local participants 104 at the location 102A can participate in discussions with a different remote participant 110 than the local participants 106 at the location 102B. For example, the remote participant 110A and the local participants 104 may engage in one side conversation or breakout meeting, and the remote participant 110B and the local participants 106 may engage in a separate side conversation or breakout meeting.

In this case, the participants 110A and 104 of the former side conversation or breakout meeting will not disturb the participants 110B and 106 of the latter side conversation or breakout meeting, and vice-versa. If a local participant 104 moves from the location 102A to the location 102B, the remote participant 110A will no longer hear the local participant 104 whereas the remote participant 110B will begin hearing the local participant 104. Similarly, if a local participant 106 moves from the location 102B to the location 102A, the remote participant 110B will no longer hear the local participant 106 whereas the remote participant 110A will begin hearing the local participant 106.

Furthermore, in the example of FIG. 1, the hub computing device 112 may manage the hybrid meeting, in that the remote participants 110 may log into the computing device 112 via their respective computing devices 128 to virtually attend the meeting, and the computing devices 128 subsequently communicate directly with the hub computing device 112. That is, in one implementation, the hub computing device 112 is part of the hybrid meeting architecture 100, and there may not be a computing device other than the hub computing device that manages the hybrid meeting.

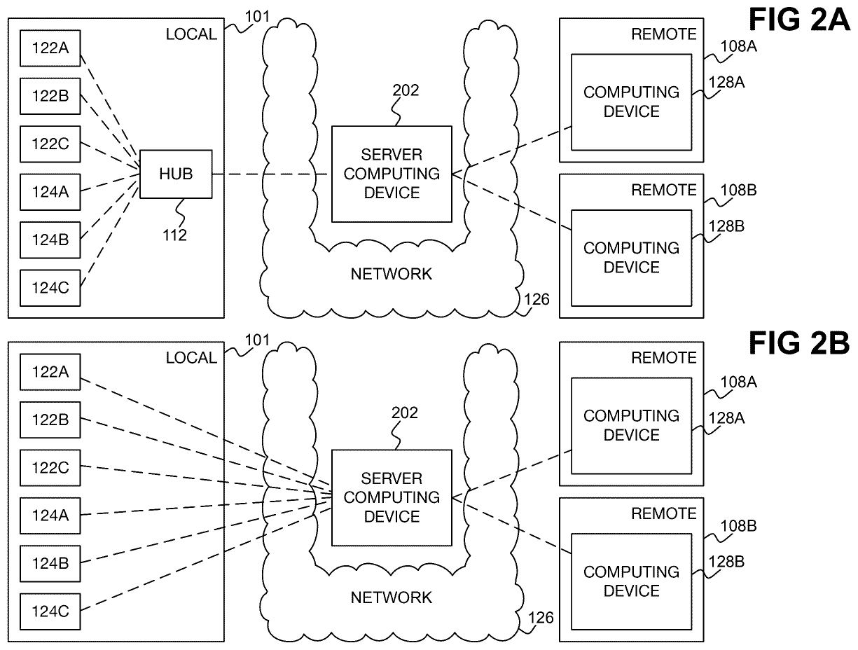

FIGS. 2A and 2B, by comparison, show other example architectures 100 for a hybrid meeting. The architecture 100 of FIG. 2A still includes the hub computing device 112 at the meeting place 101 to which the microphone devices 122 and 124 wirelessly transmit at least the uttered speech of their respective wearers. However, the architecture 100 of FIG. 2A also includes a server computing device 202 at a location other than the local meeting place 101 and the remote places 108 of the remote participants 110.

The server computing device 202 may execute a cloud service corresponding to and/or that otherwise provides hybrid meeting capability. The remote computing devices 128 thus log into and directly communicate with the server computing device 202 to virtually attend the meeting, and the hub computing device 112 similarly communicates directly with the server computing device 202. In the example of FIG. 2A, then, the hub computing device 112 and the remote computing devices 128 may not directly communicate with one another over the network 126, but rather with the server computing device 202, at least to first establish the meeting.

In comparison to FIG. 2A, the architecture 100 of FIG. 2B does not include the hub computing device 112. In this implementation, the microphone devices 122 and 124 directly transmit at least the uttered speech of their respective wearers to the server computing device 202 over the network 126 instead of to the hub computing device 112. The remote computing devices 128 at the respective remote places 108 still directly communicate with the server computing device 202 over the network 126 in FIG. 2B, as in the example of FIG. 2A.

As has been described, the hybrid meeting architecture 100 ensures that remote participants 110 are able to hear local participants 104 and 106 by virtue of the local participants 104 and 106 wearing respective microphone devices 122 and 124. Each local participant 104 and 106 can naturally hear the other local participants 104 and 106 based on their proximity and how loudly they speak. A local participant 104 or 106 can thus have a side conversation or a breakout meeting with other local participants 104 and 106 that are nearby.

To provide this same capability for the remote participants 110, the hybrid meeting architecture 100 can permit each remote participant 110 to select the group of local participants 104 and 106 that the remote participant 110 is interested in hearing. The remote computing device 128 of such a remote participant 110 will then output just the audio corresponding to uttered speech of the selected local participants 104 and 106, and not audio corresponding to uttered speech of other local participants 104 and 106 who are not part of the selected group.

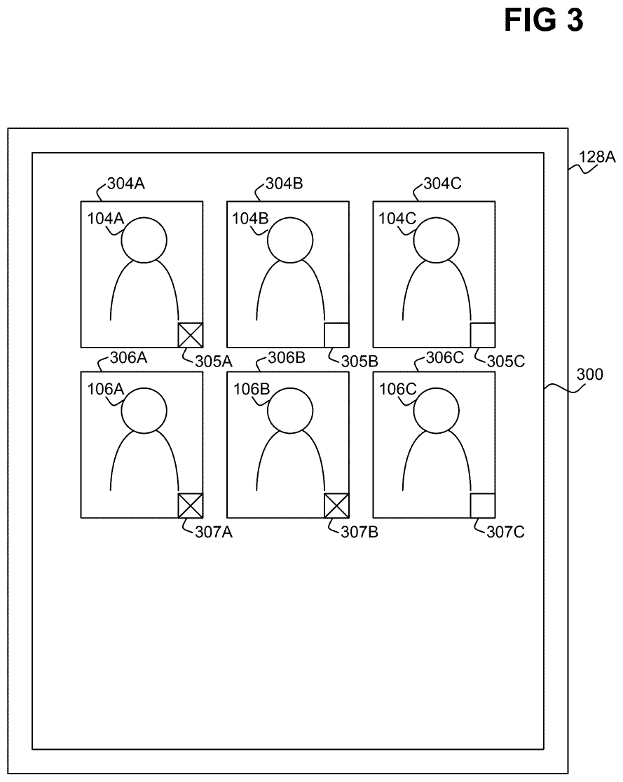

FIG. 3 shows the display 300 of a remote computing device 128 of a remote participant 110 in one example manner by which the remote participant 110 can select which local participants 104 and 106 he or she is interested in hearing. The display 300 includes windows 304A, 304B, and 304C (collectively referred to as the windows 304) for and showing the local participants 104A, 104B, and 104C, respectively. The display 300 also includes windows 306A, 306B, and 306C (collectively referred to as the windows 306) for and showing the local participants 106A, 106B, and 106C.

The remote participant 110 in the example of FIG. 3 can explicitly select the group of local participants 104 and 106 who he or she is interested in hearing. For instance, the windows 304A, 304B, and 304C can respectively include checkboxes 305A, 305B, and 305C (collectively referred to as the checkboxes 305), and the windows 306A, 306B, and 306C can respectively include checkboxes 307A, 307B, and 307C (collectively referred to as the checkboxes 307).

The remote participant 110 can thus select the checkboxes 305 and 307 of the windows 304 and 306 for the local participants 104 and 106 that the remote participant 110 is interested in hearing. Similarly, the remote participant 110 can unselect (i.e., deselect) the checkboxes 305 and 307 of the windows 304 and 306 for the local participants 104 and 106 that the remote participant 110 is not interested in hearing. In this way, the remote participant 110 selects the group of local participants 104 and 106 who he or she is interested in hearing.

In the example, the checkboxes 305A, 307A, and 307B in the windows 304A, 306A, and 306B have been selected, meaning that the remote participant 110 is interested in hearing the group including just the subset of local participants 104A, 106A, and 106B. Therefore, the remote computing device 128 outputs audio corresponding to just the uttered speech of the selected local participant group, and does not output audio corresponding to the uttered speech of the subset of the other local participants 104B, 104C, and 106C.

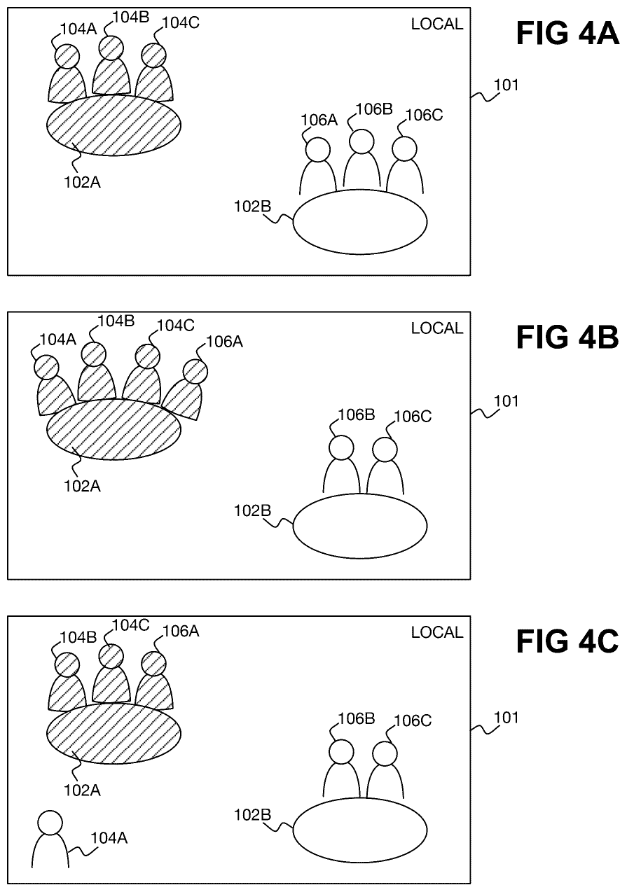

FIGS. 4A, 4B, and 4C depict another example by which a remote participant 110 can select the local participants 104 and 106 who he or she is interested in hearing, in a more implicit manner. In the example, the remote participant 110 has specified that he or she is virtually present at the physical location 102A within the meeting place 101, as indicated in the figures via shading. Therefore, the remote computing device 128 plays back just the uttered speech of the group of local participants 104 and/or 106 (also indicated in the figures via shading) located at the physical location 102A.

In FIG. 4A, for instance, the local participants 104A, 104B, and 104C are selected as the group that the remote participant 110 is interested in hearing, because the local participants 104A, 104B, and 104C are located at the physical location 102A where the remote participant 110 is virtually located. The local participants 106A, 106B, and 106C who are located elsewhere (e.g., at the physical location 102B) are not selected as part of this group in FIG. 4A.

In one implementation, the local participants 104 and 106 who the remote participant 110 has selected as being interested in hearing may receive indication that the remote participant 110 is listening to their uttered speech. For instance, the microphone devices 122 and 124 worn by the local participants 104 and 106 may have a light or other visual indicator to notify the participants 104 and 106 that one or more remote participants are listening to their uttered speech.

In FIG. 4B, the local participant 106A has moved to the physical location 102A from the physical location 102B. Therefore, the local participant 106A is automatically added to the local participant group that the remote participant 110 is interested in hearing, because the local participant 106A is now located at the physical location 102A where the remote participant 110 is virtually located. The local participant group in FIG. 4B thus now includes the local participants 104A, 104B, 104C, and 106A.

In FIG. 4C, the local participant 104A has moved away from the physical location 102A. Therefore, the local participant 104A is automatically removed from the local participant group that the remote participant 110 is interested in hearing, because the local participant 104A is no longer located at the physical location 102A where the remote participant 110 is virtually located. The local participant group in FIG. 4C thus now includes the local participants 104B, 104C, and 106A.

In the implementation of FIGS. 4A, 4B, and 4C, then, the remote participant 110 does not explicitly select the group of local participants 104 and 106 that he or she is interested in hearing, unlike in the implementation of FIG. 3. Rather, the remote participant 110 explicitly selects the physical location within the hybrid meeting place 101 at which he or she is virtually located. The local participants 104 and 106 that are currently physically located at this location are automatically selected as the group that the remote participant 110 is interested in hearing.

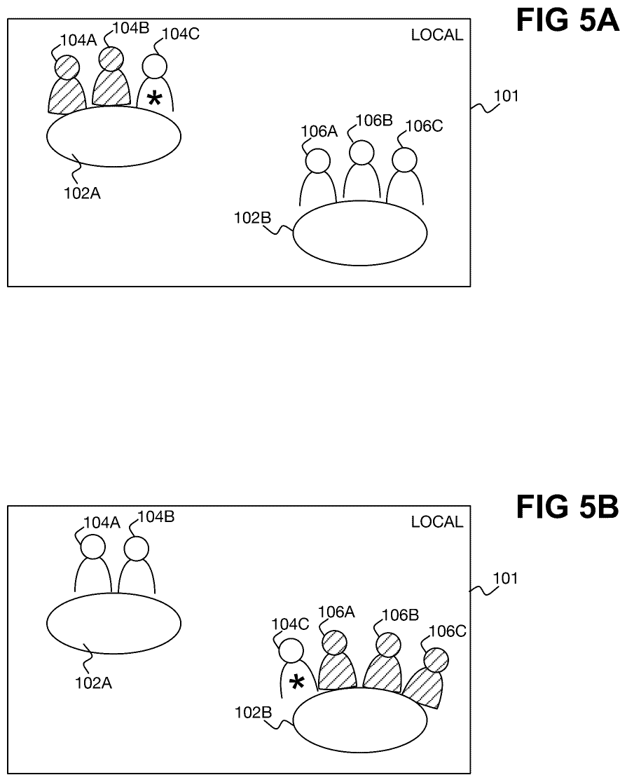

FIGS. 5A and 5B depict another example by which a remote participant 110 can select the local participants 104 and 106 who he or she is interested in hearing in a more implicit manner. In the example, the remote participant 110 has specified that he or she wishes to virtually follow (i.e., remain virtually located at the same location as) the local participant 104C within the meeting place 101, who is denoted with an asterisk in the figures. Therefore, the remote computing device 128 plays back just the uttered speech of the group of local participants 104 and 106 including the local participant 104C and the other local participants 104 and/or 106 (indicated in the figure via shading) who are physically proximate to the local participant 104C.

In FIG. 5A, for instance, the local participant 104C is at the physical location 102A, and is thus physically proximate to the local participants 104A and 104B at the same location 102A. The local participants 104A, 104B, and 104C are therefore selected as the group that the remote participant 110 is interested in hearing. The local participants 106A, 106B, and 106C who are not physically proximate to the local participant 104C (e.g., because they are at the physical location 102B) are not selected as part of this group in FIG. 5A.

In FIG. 5B, the local participant 104C who the remote participant 110 is virtually following has moved from the physical location 102A to the physical location 102B within the meeting place 101. Therefore, the local participants 106A, 106B, and 106C who are now proximate to the local participant 104C (e.g., because they are at the same physical location 102B) are automatically added to the local participant group that the remote participant 110 is interested in hearing. The local participants 104A and 104B are removed from the group, because they are no longer proximate to the local participant 104C.

In the implementation of FIGS. 5A and 5B, then, the remote participant 110 does not explicitly select the group of local participants 104 and 106 that he or she is interested in hearing, as in the implementation of FIGS. 4A, 4B, and 4C and unlike the implementation of FIG. 3. However, whereas in the implementation of FIGS. 4A, 4B, and 4C the remote participant 110 explicitly selects an absolute physical location within the meeting place 101 at which he or she is virtually located, in the implementation of FIGS. 5A and 5B the remote participant 110 does not. Rather, the remote participant 110 explicitly selects a particular local participant 104 or 106 that he or she virtually follows (which the remote participant 110 does not do in the implementation of FIGS. 4A and 4B).

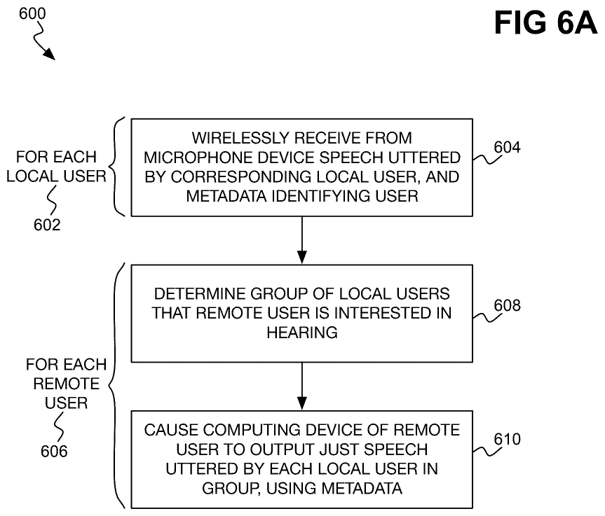

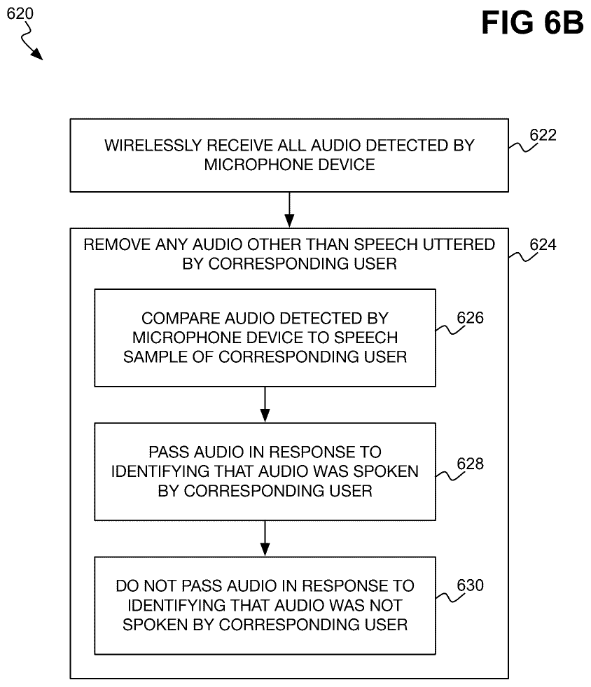

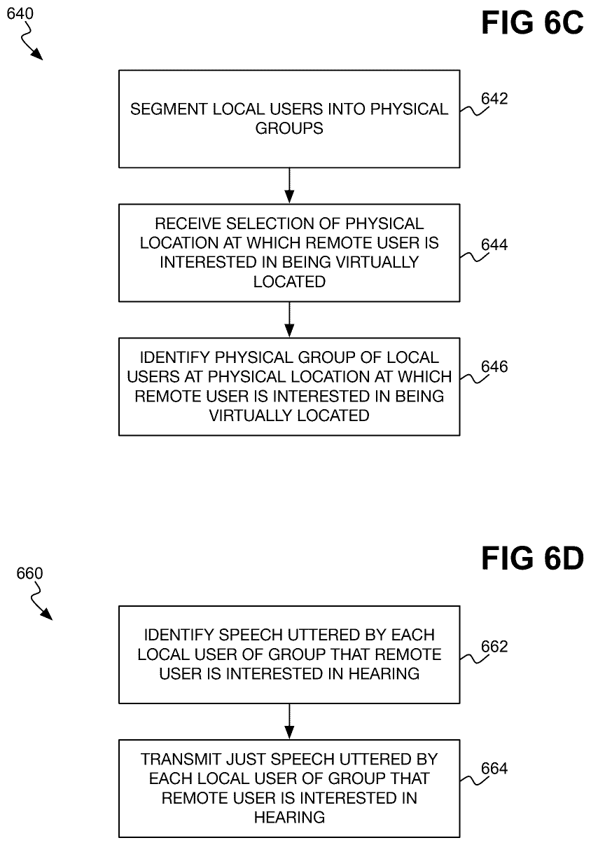

FIGS. 6A, 6B, 6C, and 6D respectively show example methods 600, 620, 640, and 660 that the hub computing device 112 or the server computing device 202 can perform in the hybrid meeting architecture 100. The methods 600, 620, 640, and 660 can be implemented as program code stored on a non-transitory computer-readable data storage medium. A processor of the hub computing device 112 or server computing device 202 executes the program code to perform the methods 600, 620, 640, and 660.

Referring first to FIG. 6A, the method 600 includes for each local user (602)—i.e., for each local participant 104 and 106—wirelessly receiving, from the microphone device 122 or 124 worn by that local user, (at least) the speech uttered by the local user, along with metadata identifying the local user (604). That is, from a given microphone device 122 or 124, the speech uttered by the corresponding local user is received, along with metadata identifying this corresponding local user.

In one implementation, a microphone device 122 or 124 wirelessly transmits only audio that has been detected which includes speech uttered by its corresponding local user. This means that the hub computing device 112 or server computing device 202 only receives from each microphone device 122 or 124 the uttered speech of its corresponding local user, and not other audio that the microphone device 122 or 124 may have detected. Therefore, the hub computing device 112 or server computing device 202 does not itself have to identify whether the audio received from a microphone device 122 or 124 includes uttered speech of its corresponding local user.

Referring to FIG. 6B, however, in another implementation, per method 620, the hub computing device 112 or server computing device 202 may receive from a microphone device 122 or 124 all audio that the device 122 or 124 has detected (622), regardless of whether the audio includes the uttered speech of its corresponding local user. In this case, the hub computing device 112 or server computing device 202 has to remove any audio detected by the microphone device 122 or 124 other than speech uttered by its corresponding local user (624).

For instance, the method 620 may include comparing the audio detected and wirelessly transmitted by the microphone device 122 or 124 to a previously recorded speech sample of its corresponding local user (626), to identify whether the audio detected by the device 122 or 124 was spoken by the same person as the uttered speech sample. The method 620 includes passing the wirelessly received audio in response to identifying that it was spoken by the same person as the uttered speech sample (628), and not passing the audio in response to identifying that it was not (630).

In other implementations, audio other than speech uttered by the local user in question can be removed in (624) in different ways. For instance, a machine learning model may be employed. The model may have been previously trained for the local user, such as based on speech samples uttered by the local user. The audio received from the microphone device 122 or 124 may then be input into the model, which then responsively outputs whether or not the audio was spoken by the person in question.

In still another implementation, a virtual directional microphone may be created using a machine learning model, to focus just on a particular local user or a particular location at which the local user is located. The audio received from the microphone device 122 or 124 may be input into such a machine learning model that is trained for that user or location. The output from the machine learning model is the speech uttered by the local user, or just speech uttered at the location.

Referring back to FIG. 6A, the method 600 includes then performing the following for each remote user (606)—i.e., for each remote participant 110. Specifically, the method 600 includes determining the group of local users that the remote user is interested in hearing (608). In one implementation, the group of local users that the remote user is interested in hearing may be determined in that a remote user may explicitly specify the local user group, as has been described above in reference to FIG. 3. In this case, the hub computing device 112 or server computing device 202 may receive selection of the subset of local users that the remote user is interested in hearing. As such, the group of local users is explicitly defined by the remote user.

There can be different arrangements as well. For instance, remote users may be able to join any group of local users of their choice, and thus “roam” freely among the various groups. Remote users may have to first request joining a group of local users, where the group then has to approve the request before the remote users can join the group. Remote users may not be able to join a group of local users unless invited to do so.

Furthermore, when joining a group, a remote user may join as a passive listener or active speaker, and some local users in the group may choose to be in listen-only mode or be in a mode in which they are also be able to speak. These modes can be controlled and configured based on meeting dynamics and needs.

Referring to FIG. 6C, in another implementation, per the method 640, the hub computing device 112 or server computing device 202 may determine the group of local users that a remote user is interested in hearing as follows. The local user group is not explicitly specified, but rather is implicitly specified, as has been described above in reference to FIGS. 4A-4C and FIGS. 5A-5B in differing cases.

For instance, the method 640 may include segmenting the local users among physical groups (642), where each physical group includes those local users located at the same physical location within the hybrid meeting place 101. For example, the specific location of the microphone device 122 or 124 of each local user may be detected, such that the local users are segmented based on these detected locations.

As another example, the hub computing device 112 or server computing device 202 may wirelessly receive from each microphone device 122 or 124 the identification of the other microphone devices 122 and 124 that are physically proximate, or the audio speakers to which each microphone device 122 or 124 are physically proximate. The local users can then be segmented among physical groups corresponding to different locations within the hybrid meeting place 101 based on which microphone devices 122 or 124 are proximate to one another, or based on which audio speakers each microphone device 122 or 124 is proximate to.

The method 640 includes receiving selection of the physical location within the hybrid meeting place 101 at which the remote user is interested in being virtually located (644). For example, the physical location within the hybrid meeting place 101 at which the remote user is interested in being virtually located may be absolutely specified, as has been described in relation to FIGS. 4A-4C. As another example, the physical location may be relatively specified, via the remote user specifying a particular local user who he or she wishes to follow or shadow, as has been described in relation to FIGS. 5A-5B. The physical location at which the remote user is virtually located is thus wherever the selected local user is in the meeting place 101.

The method 640 includes then identifying the physical group of local users at the physical location at which the remote user is interested in being virtually located (646). For example, as has been described in relation to FIGS. 4A-4C, the group of local users at the physical location at which the remote user is virtually present may be identified as the group of local users that the remote user is interested in hearing. As another example, as has been described in relation to FIGS. 5A-5B, the group of local users including the local user selected be the remote user and other, physically proximate local users may be identified as the group of local users that the remote user is interested in hearing.

Referring back to FIG. 6A, the method 600 further includes causing the computing device 128 of the remote user to output just the speech uttered by each local user of the determined group, using the metadata identifying the corresponding local user of each microphone device 122 or 124 (610). The metadata received from a microphone device 122 or 124 is used along with the speech uttered by the corresponding local user of that device 122 or 124 to determine if the corresponding local user belongs to the local user group that the remote user is interested in hearing.

Referring to FIG. 6D, for instance, per the method 660, the host computing device 112 or server computing device 112 may identify the speech uttered by each local user of the local user group that the remote user is interested in hearing based on this metadata (662). If the metadata received along with speech from a microphone device 122 or 124 identifies a local user belonging to the local user group, then that speech is identified as being uttered by the local user and thus speech that the remote user is interested in hearing. Speech uttered just by each such local user of the local user group is wirelessly transmitted, along with the metadata, to the computing device 128 of the remote user (664) for output.

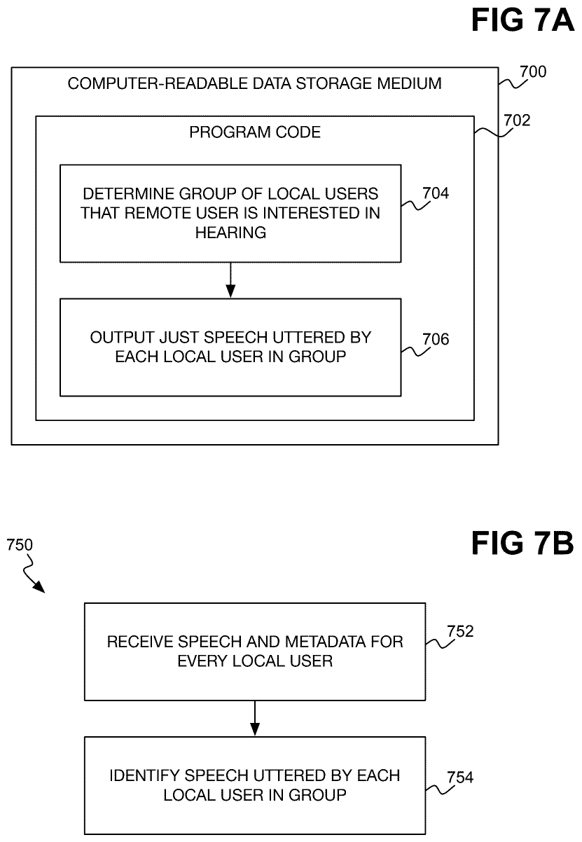

FIG. 7A shows an example non-transitory computer-readable data storage medium 700 storing program code 702 that can be executed by the remote computing device 128 of a remote user (i.e., a remote participant 110 of the hybrid meeting). The program code 702 is executable by a processor of the remote computing device 128 to perform processing. The processing includes determining the group of local users physically at the meeting place 101 that the remote user is interested in hearing (704).

For example, as described in reference to FIG. 3, the remote computing device 128 may receive selection of the subset of the local users that the remote user is interested in hearing, such that the remote user explicitly defines the local user group. As another example, the remote computing device 128 may receive selection of a physical location in the meeting place 101 at which the remote user is interested in being virtually located, either absolutely per FIGS. 4A-4C or relatively via selection of a particular local user that the remote user wants to follow per FIGS. 5A-5B.

The processing includes then outputting just speech uttered by each local user in the determined local user group (706). When outputting the speech uttered by a local user, the remote computing device 128 may identify who that local user is. For example, the remote computing device 128 may highlight the window 304 in which the local user is being displayed when playing back the speech uttered by that local user. In this way, the remote user is able to discern who is currently speaking (where one or more local users may be speaking at the same time).

In one implementation, the hub computing device 112 or server computing device 202 may transmit to the remote computing device 128 the uttered speech and metadata just for those local users who belong to the local user group that the remote user is interested in hearing, and not for local users who do not belong to the group. This means that the remote computing device 128 can simply output the speech uttered by every local user that has been received, since the remote computing device 128 will not receive speech if it was uttered by a local user that is not part of the group.

Referring to FIG. 7B, however, in another implementation, per processing 750, the hub computing device 112 or sever computing device 202 may transmit to the remote computing device 128 the uttered speech and metadata for every local user, regardless of whether a given local user belongs to the local user group that the remote user is interested in hearing. In this case, the remote computing device 128 receives the uttered speech and metadata for every local user (752).

Therefore, the remote computing device 128 itself has to identify the speech uttered by each local user of the group that the remote user is interested in hearing, based on the received metadata (754). That is, when the remote computing device 128 receives uttered speech and metadata, the device 128 has to identify whether the metadata is for a local user belonging to the group that the remote user is interested in hearing, similar to as has been described in relation to (662) of FIG. 6D. Only when the metadata received along with uttered speech corresponds to a local user in the local user group is the speech output.

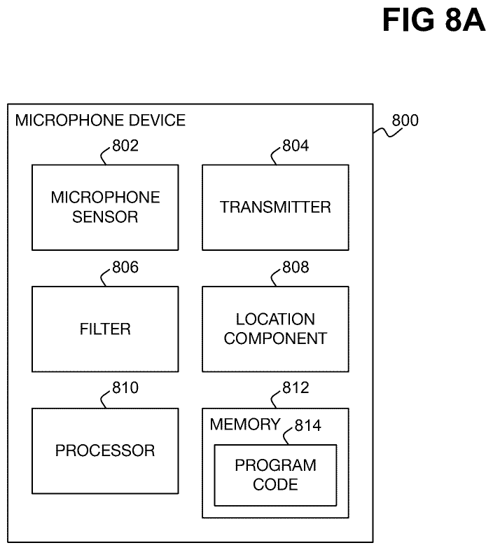

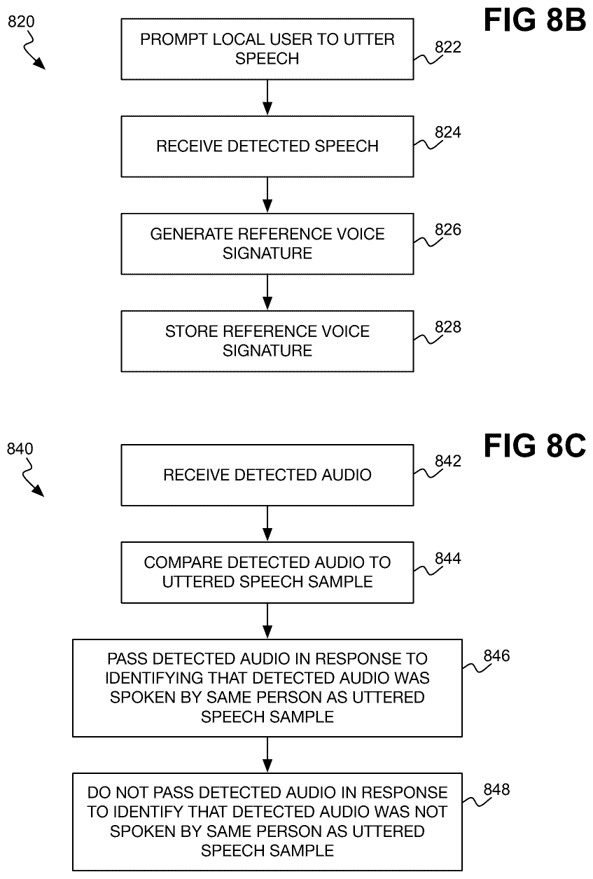

FIG. 8A shows an example microphone device 800 that a local user may wear. That is, the microphone device 800 may be the microphone device 122 or 124 that a local participant 104 or 106 wears. The microphone device 800 includes a microphone sensor 802 and a wireless transmitter 804. The microphone device 800 may further include a filter 806 and/or a location component 808. The microphone device 800 may also include a processor 810 and a memory 812 storing program code 814.

The microphone device 800 can include other components as well, in addition to or in lieu of those depicted in FIG. 8A. For example, the microphone device 800 can include a rechargeable or replaceable battery to provide internal power to its components. The microphone device 800 may include one or more light-emitting diodes (LEDs) or other visual indicators, and/or a display such as a liquid crystal display (LCD) to provide information including a current mode of the device 800. The microphone device 800 may include one or more switches, such as buttons, by which a local user can provide input to the device 800 and/or turn the device 800 on and off.

The microphone sensor 802 detects audio proximate to the microphone device 800, including speech uttered by the wearer of the device 800 (i.e., the corresponding local user for the device 800). The terminology sensor is used herein to differentiate the microphone sensor 802 from the microphone device 800 as a whole. That is, while the device 800 includes a microphone (i.e., the sensor 802), the device 800 also includes other components, whereas the sensor 802 refers to just the microphone itself.

The filter 806 can be implemented as special-purpose hardware circuit, such as an application-specific integrated circuit (ASIC) or another type of circuit, or may be implemented as a general-purpose circuit. For example, the filter 806 may in one implementation be the processor 810 and the memory 812 storing program code 814, in that the program code 814 is executed by the processor 810 to at least perform the functionality of the filter 806.

The filter 806 removes, from the audio detected by the microphone sensor 802, any audio other than speech uttered by the local user corresponding to and wearing the microphone device 800. The filter 806 thus generates filtered audio including just the speech uttered by this local user. In an implementation in which the microphone device 800 includes the filter 806, therefore, just uttered speech of the corresponding local user is transmitted by the microphone device 800, and not all detected audio.

The wireless transmitter 804 wirelessly transmits at least the speech uttered by the corresponding local user, along with metadata identifying the local user. In the case in which the filter 806 is included, the transmitter 804 transmits, along with the metadata of the corresponding local user, the filtered audio. That is, the transmitter 804 transmits detected audio only if it includes speech uttered by the wearer of the microphone device 800. In the case in which the filter 806 is not included, by comparison, the transmitter 804 transmits, along with the metadata of the corresponding local user, all detected audio.

The processor 810 and the memory 812 may be implemented as separate hardware circuits or as part of the same hardware circuit. The memory 812 is one example of a non-transitory computer-readable data storage medium. The program code 814 stored by the memory 812 is executed by the processor 810 to perform processing. The memory 812 may also store data generated as a result of such processing, which may be used by the filter 806 in performing its functionality.

Referring to FIG. 8B, for instance, the processor 810 may execute the program code 814 to perform processing 820 to calibrate the microphone device 800 for a local user when the local user puts on (viz., first wears) the device 800. Such calibration can be performed so that the filter 806 can subsequently remove detected audio that is not speech uttered by the local user. That is, the calibration may be performed so that the filter 806 passes detected audio only if the audio includes speech uttered by the local user.

For instance, when a local user first enters the meeting room or other meeting place 101, he or she may pick up a microphone device 800 that has been provided at the place 101. The local user may turn on the device 800, which causes the microphone device 800 to enter a calibration mode to tie the device 800 specifically to the local user. When the microphone device 800 is turned off, such linking to the local user may be automatically erased or otherwise removed. In another implementation, such as in office settings, such linking may be preserved for a local user for a specified length of time to facilitate repeated use without having to engage in the linking process each time.

Specifically, the processing 820 includes prompting the local user to utter a speech sample (822). For example, a visual indicator corresponding to the calibration mode may be lit, or a corresponding message may be displayed. The processing 820 includes then receiving speech detected by the microphone sensor 802 in response (824). That is, the audio detected by the microphone sensor 802 at this time is assumed to be speech uttered by the local user that has put on the microphone device 800.

The processing 820 includes, in one implementation, generating a reference voice signature of the local user from the detected speech (826). The reference voice signature corresponds to the voice of the local user, and may be generated by performing signal processing on the detected speech in the frequency or other domain, for instance. Therefore, when the signal processing is performed on subsequently detected audio, if the resulting voice signature matches the reference voice signature, the detected audio is determined as including speech spoken by the local user in question.

The generated reference voice signature of the local user is stored in the memory 812 (828). More generally, the speech sample uttered by the local user is stored. In other words, the uttered speech sample of the local user is stored in the memory 812 in that the voice signature generated from the uttered speech sample is stored. For instance, the uttered speech sample may be temporarily stored until the voice signature is generated and stored, at which time the sample is deleted. The uttered speech sample (e.g., the reference voice signature) may also or instead be transmitted to the hub computing device 112 or the server computing device 202 in an implementation in which the device 112 or 202 determines whether audio detected by the microphone device 202 constitutes speech uttered by the local user.

Referring next to FIG. 8C, after the microphone device 800 has been calibrated for a local user in a calibration mode, the filter 806 may perform processing 840 in an operational mode to remove any audio other than speech uttered by the local user from subsequently detected audio. The filter 806 receives audio detected from the sensor 802 (842), and compares the detected audio to the stored speech sample known (or presumed) to have been spoken by the local user (844). The sensor 802 may itself intrinsically have a very short proximity detection, in that the sensor 802 is only able to detect audio from a limited physical around the sensor 802.

For instance, the filter 806 may generate a voice signature from the detected audio and compare the voice signature to a stored reference voice signature that was previously generated. In this way, the filter 806 thus can identify whether the detected audio was spoken by the same person as the uttered speech sample.

The processing 840 includes passing the detected audio to the transmitter 804 for wireless transmission in response to identifying that the detected audio was spoken by the same person as the uttered speech sample (846). The processing 840 similarly includes not passing the detected audio to the transmitter 804 for wireless transmission in response to identifying that the detected audio was not spoken by the same person as the uttered speech sample (848).

Referring back to FIG. 8A, the location component 808 of the microphone device 800 may be a beacon circuit that permits the hub computing device 112 at the meeting place 101 to detect the physical location of the microphone device 800 within the meeting place 101. For example, the beacon circuit may periodically transmit a signal identifying the microphone device 800 on which basis the hub computing device 112 is able to determine the physical location of the device 800. In one implementation, the transmitter 804 may be considered the beacon circuit, such that the hub computing device 112 is able to detect the physical location of the device 800 based on the signal including the detected audio and metadata transmitted by the transmitter 804.

The location component 808 may instead by a location-identification circuit, such as a global positioning system (GPS) circuit, an indoor positioning system (IPS) circuit, or another type of location-identification circuit. The location-identification circuit itself identifies the physical location of the microphone device 800 within the meeting place 101 (i.e., instead of the hub computing device 112 detecting the physical location of the device 800). The wireless transmitter 804 therefore transmits the identified physical location of the microphone device 800, either periodically or when transmitting detected audio and metadata.

The location component 808 may instead be a physical proximity sensor to identify other microphone devices 122 and 124 that are physically proximate to the microphone device 800. The transmitter 804 may be considered the physical proximity sensor in one implementation, such as in the case in which the transmitter 804 is a Bluetooth transceiver. Such a transceiver can receive signals including detected audio and metadata transmitted by other microphone devices 122 and 124 to determine which are physically proximate to the microphone device 800, for instance. The transmitter 804 transmits identification of such physically proximate other microphone devices 122 and 124 when the microphone device 800 transmits detected audio and metadata.

In another implementation, the location component 808 may be a physical proximity sensor to identify the audio speaker to which the microphone device 800 is physical proximate, where there are multiple audio speakers within the meeting place 101 in correspondence with different groups of local users. The audio speaker (or speakers) for a given group are used to output audio (i.e., uttered speech) from remote users who are participating in that group. The transmitter 804 can thus transmit identification of the speakers to which it is physically proximate, or the speaker to which it is closest.

This latter implementation can permit local users to dynamically roam among different groups within the meeting place 101. A local user is considered as joining the group corresponding to the audio speaker to which the local user is closest. If the local user physically moves away from the audio speaker for that group and closer to the audio speaker for a different group, the local user automatically is switched from the former group to the latter group. The remote users participating in the former group will automatically no longer be able to hear the local user, and the remote users participating in the latter group will automatically start hearing the local user.

As has been noted above, the microphone device 800 may be a purpose-built device in one implementation. In this case, the microphone device 800 may include at least the microphone sensor 802, the transmitter 804, the processor 810, and the memory 812 storing program code 814. The device 800 may also include the filter 806 and/or the location component 808. The microphone device 800 in this implementation can be purpose-built for usage in a hybrid meeting as has been described above. For example, the device 800 may be built to be used in conjunction with the hub computing device 112 of FIG. 1 per FIG. 2A, or may be built to be used to communicate with the computing devices 128 directly over a network 126 per FIG. 2B.

In another implementation, the microphone device 800 may as also has been noted above be a basic device, including just the microphone sensor 802 and the transmitter 804 of the components depicted in FIG. 8A. That is, the device 800 may not include the filter 806, the location component 808, the processor 810, or the memory 812 storing the program code 814. In this implementation, the hub computing device of FIG. 1 or FIG. 2A may be designed to receive the audio detected by the sensor 802 and transmitted by the transmitter 804. The microphone device 80 may not perform any processing, but have a minimal number of components in order to reduce cost.

In still another implementation, the microphone device 800 may be as has been noted above be a general-purpose device, such as a smartphone. The device 800 may thus already have the microphone sensor 802, the transmitter 804, the processor 810, and the memory 812, and may further include the location component 808 as well. The program code 814 may be provided on the microphone device 800 in the form of an app that is installed on the device 800. The app is programmed to communicate with the hub computing device of FIG. 1 per FIG. 2A, or with the computing devices 128 directly over a network 126 per FIG. 2B. The ubiquity of smartphone devices therefore can be leveraged to realize the techniques that have been described.

The techniques described herein ultimately improve the user experience of remote participants 110 in a hybrid meeting via microphone devices 122 and 124 worn by local participants 104 and 106 of the meeting. When a local participant 104 or 106 speaks, his or her microphone device 122 or 124 will detect the uttered speech. Therefore, even when local participants 104 and 106 engage in side conversations or breakout meetings, the remote participants 110 will be able to hear such local participants 104 and 106 that they are interested in hearing and also will be able to actively participate in discussions with these local participants 104 and 106.

We claim:

1. A method comprising:
wirelessly receiving, by a processor and from each of a plurality of microphone devices respectively worn by a plurality of local users participating in a meeting and physically present at a place of the meeting, speech uttered by a corresponding local user and detected by the microphone device, and metadata identifying the corresponding local user;
determining, by the processor, a group of the local users that a remote user participating in the meeting and not physically present at the place of the meeting is interested in hearing; and
causing, by the processor, a computing device of the remote user to output just the speech uttered by each local user of the determined group of the local users that the remote user is interested in hearing, using the metadata identifying the corresponding local user of each microphone device.

2. The method of claim 1, wherein wirelessly receiving, from each microphone device, the speech uttered by the corresponding local user comprises:
wirelessly receiving all audio detected by the microphone device; and
removing, from the audio detected by the microphone device, any audio other than the speech uttered by the corresponding local user.

3. The method of claim 2, wherein removing, from the audio detected by the microphone device, any audio other than the speech uttered by the corresponding local user comprises:
comparing the audio detected by the microphone device to an uttered speech sample of the corresponding user to identify whether the audio detected by the microphone device was spoken by a same person as the uttered speech sample;
passing the audio detected by the microphone device in response to identifying that the audio detected by the microphone device was spoken by the same person as the uttered speech sample; and
not passing the audio detected by the microphone device in response to identifying that the audio detected by the microphone device was not spoken by the same person as the uttered speech sample.

4. The method of claim 1, wherein determining the group of the local users that the remote user is interested in hearing comprises:
receiving, from the computing device of the remote user, selection of a subset of the local users by the remote user, such that which of the remote users belong to the group that the remote user is interested in hearing is explicitly defined by the remote user.

5. The method of claim 1, wherein determining the group of the local users that the remote user is interested in hearing comprises:
segmenting, by the processor, the local users among a plurality of physical groups, each physical group including those of the local users that are located at a same physical location within the place of the meeting;
receiving, from the computing device of the remote user, selection of a physical location within the place of the meeting at which the remote user is interested in being virtually located; and
identifying, as the group of the local users that the remote user is interested in hearing, the physical group of the local users located at the physical location at which the remote user is interested in being virtually located.

6. The method of claim 5, wherein determining the group of the local users that the remote user is interested in hearing further comprises:
detecting, by the processor, a specific location of the microphone device of each local user within the place of the meeting,
wherein the local users are segmented among the physical groups based on the specific location of the microphone device of each local user.

7. The method of claim 5, wherein, in addition to the speech uttered by the corresponding local user and the metadata identifying the corresponding local user, identification of the microphone devices or audio speakers that are physically proximate is wirelessly received from each microphone device,
and wherein the local users are segmented among the physical groups based on the microphone devices or audio speakers that are physically proximate to each microphone device.

8. The method of claim 1, wherein causing the computing device of the remote user to output just the speech uttered by each local user of the determined group that the remote user is interested in hearing comprises:
identifying the speech uttered by each local user of the determined group that the remote user is interested in hearing, based on the metadata; and
transmitting, to the computing device of the remote user, the speech uttered by just each local user of the determined group, as has been identified based on the metadata, and the metadata received from the microphone device worn by the local user,
wherein the computing device of the remote user outputs the speech uttered by every local user that has been received.

9. The method of claim 1, wherein causing the computing device of the remote user to output just the speech uttered by each local user of the determined group that the remote user is interested in hearing comprises:
transmitting, to the computing device of the remote user, the speech and the metadata received from the microphone device worn by every local user,
wherein the computing device of the remote user outputs just the speech uttered by each local user of the determined group that the user is interested in hearing.

10. A non-transitory computer-readable data storage medium storing program code executable by a processor of a computing device of a remote user participating in a meeting and not physically present at a place of the meeting to perform processing comprising:
determining, from a plurality of local users participating in the meeting and physically present at the place of the meeting, a group of the local users that a remote user is interested in hearing, the local users respectively wearing microphone devices that each wirelessly transmit speech uttered by a corresponding local user detected by the microphone device and metadata identifying the corresponding local user; and
outputting just the speech uttered by each local user of the determined group of the local users that the remote user is interested in hearing, using the metadata identifying the corresponding local user of each microphone device.

11. The non-transitory computer-readable data storage medium of claim 10, wherein determining the group of the local users that the remote user is interested in hearing comprises:
receiving selection of a subset of the local users by the remote user, such that which of the remote users belong to the group that the remote user is interested in hearing is explicitly defined by the remote user.

12. The non-transitory computer-readable data storage medium of claim 10, wherein determining the group of the local users that the remote user is interested in hearing comprises:
receiving selection of a physical location within the place of the meeting at which the remote user is interested in being virtually located,
wherein the group of the local users that the remote user is interested in hearing is identified as the local users located at the physical location at which the user is interested in being virtually located.

13. The non-transitory computer-readable data storage medium of claim 10, wherein outputting just the speech uttered by each local user of the determined group of the local users that the remote user is interested in hearing comprises:
receiving, just for each local user of the determined group that the user is interested in hearing, the speech and the metadata received from the microphone device worn by the local user,
wherein the speech uttered by every local user that has been received is output.

14. The non-transitory computer-readable data storage medium of claim 10, wherein outputting just the speech uttered by each local user of the determined group of the local users that the remote user is interested in hearing comprises:
receiving, for every local user, the speech and the metadata received from the microphone device worn by the local user; and
identifying the speech uttered by each local user of the determined group that the remote user is interested in hearing, based on the metadata,
wherein the speech uttered by each local user of the determined group, as has been identified based on the metadata, is output.

15. A microphone device to be worn by a local user physically present at a place of a meeting and participating in the meeting along with other local users physically present at the place and participating in the meeting, the device comprising:
a microphone sensor to detect audio proximate to the device;
a filter to remove, from the detected audio, any audio other than speech uttered by the local user, such that the filter generates filtered audio including just the speech uttered by the local user; and
a transmitter to wirelessly transmit the filtered audio and metadata identifying the local user.

16. The microphone device of claim 15, further comprising:
a processor; and
a memory storing program code executable by the processor to calibrate the device for the local user by receiving an uttered speech sample of the local user from the microphone sensor, and storing the uttered speech sample in the memory,
wherein the filter is to remove, from the detected audio, any audio other than the speech uttered by the local user by:
comparing the detected audio to the uttered speech sample to identify whether the detected audio was spoken by a same person as the uttered speech sample;
passing the detected audio to the transmitter for wireless transmission in response to identifying that the detected audio was spoken by the same person as the uttered speech sample; and
not passing the detected audio to the transmitter for wireless transmission in response to identifying that the detected audio was not spoken by the same person as the uttered speech sample.

17. The microphone device of claim 16, wherein the program code is executable by the processor to calibrate the device for the local user by further generating a reference voice signature corresponding to a voice of the local user from the uttered speech sample,
wherein the uttered speech sample is stored in the memory in that the reference voice signature corresponding to the voice of the local user is stored in the memory,
wherein the filter is to remove, from the detected audio, any audio other than the speech uttered by the local user by further generating a voice signature from the detected audio,
and wherein the detected audio is compared to the uttered speech sample in that the voice signature generated from the detected audio is compared to the reference voice signature.

18. The microphone device of claim 15, further comprising:
a beacon circuit to permit a computing device at the place of the meeting to detect a physical location of the microphone device within the place of the meeting.

19. The microphone device of claim 15, further comprising:
a location-identification circuit to identify a physical location of the microphone device within the place of the meeting,
wherein the transmitter is to wirelessly transmit the identified physical location of the microphone device.

20. The microphone device of claim 15, further comprising:
a physical proximity sensor to identify other microphone devices of the other local users that are physically proximate to the microphone device, or to identify audio speakers to which the microphone device is physically proximate,
wherein the transmitter is to wirelessly transmit the identified other microphone devices that are physically proximate to the microphone device, or the identified audio speakers to which the microphone device is physically proximate.
